(19) United States
(12) Patent Application Publication
(10) Pub. No.: US 2026/0235217 A1
(43) Pub. Date: Aug. 13, 2026

(54) PRESSURE EQUALIZATION DEVICE FOR A BATTERY HOUSING

(71) Applicant: ILLINOIS TOOL WORKS INC., Glenview, IL (US)

(72) Inventors: Fulvio Pacifico Yon, Glenview, IL (US); Ilaria Giacomelli, Glenview, IL (US)

(21) Appl. No.: 19/156,678

(22) PCT Filed: Aug. 15, 2023
(86) PCT No.: PCT/IB2023/000254

§ 371 Date: Aug. 14, 2025

(30) Foreign Application Priority Data
Feb. 22, 2023 (EP) 23157922.8
Mar. 17, 2023 (EP) 23162552.6

(51) Int. Cl. F16K 17/02; H01M 50/325

(52) U.S. Cl. CPC F16K 17/02; H01M 50/325

(57) ABSTRACT

The invention relates to a pressure equalizing device (1, 101, 301) for a battery case. The device comprises a cage (2, 102, 302) describing a fluid passage (23, 123, 323) and a valve member (3, 103, 203, 303) covering the fluid passage. The valve member comprises a hole (33, 133, 233, 333) through its thickness and a membrane (34, 134, 234, 334) attached to the valve member and covering the hole. The membrane is configured to equalize, in-use, the pressure within the battery case with the ambient pressure outside the battery case, while the valve member is configured to move or deform in a reversible manner to a predetermined pressure difference between the inside and the outside of the battery case to prevent overpressure within the battery case.

### TECHNICAL FIELD OF THE INVENTION

The invention relates to the field of pressure equalizing devices making it possible to compensate for the pressure variation within a battery and to systematically release the pressure in the event of an overpressure (for example, by means of a degassing device).

### TECHNICAL BACKGROUND

The use of a pressure compensation member for batteries is known from patent EP3385584, filed by Freudenberg. More specifically, this member combines the function of pressure compensation in normal operation but also that of reducing the overpressure during an emergency degassing.

### SUMMARY OF THE INVENTION

The invention relates to a pressure equalizing device for a battery case.

The device can comprise a cage. The cage can describe a fluid passage. The device can comprise a valve member, for example a flexible umbrella. The valve member can cover the fluid passage. The valve member can comprise a hole, for example through its thickness. The valve member can comprise a membrane that can be attached to the valve member and/or can cover the hole.

The membrane can be configured to equalize, in use, the pressure within the battery case with the ambient pressure outside the battery case. The valve member can be configured to move or deform in a reversible manner, for example to a predetermined pressure difference between the interior and exterior of the battery case, to prevent an overpressure within the battery case.

The invention also relates to a pressure equalizing device for a battery case, the device comprising a cage describing a fluid passage, and a valve member covering the fluid passage, the valve member comprising a hole through its thickness and a membrane attached to the valve member and covering the hole, wherein the membrane is configured to equalize, in use, pressing the inside of the battery case with the ambient pressure outside the battery case while the valve member is configured to move or reversibly deform to a predetermined pressure difference between the inside and the outside of the battery case to prevent overpressure within the battery case.

Thus, the invention provides a pressure equalization device that is both compact and allows a significant degassing flow.

The invention also relates to a valve member for a pressure equalizing device with a fluid passage intended to be covered by the valve member, the valve member comprising a hole through its thickness and a membrane attached to the valve member and covering the hole, wherein the membrane is configured to equalize, in use, the pressure within a battery case with the ambient pressure outside the battery case while the valve member is configured to move or reversibly deform to a predetermined pressure difference between the inside and the outside of the battery case to prevent overpressure within the battery case.

Also, the membrane can be gas permeable and liquid impermeable, for example to allow air to pass through it to equalize the pressure within the battery case with the ambient pressure outside the battery case. The membrane can be embedded or overmolded in the valve member. In addition, all holes can be covered with a membrane or each hole can be covered with a respective membrane.

Alternatively, the membrane can be configured to move or deform in a reversible manner, for example to equalize the pressure within the battery case with the ambient pressure outside the battery case.

The valve member can comprise a disc. The valve member or disc can comprise a canopy. At least a portion of the hole can be next to the disc or canopy. At least a portion of the hole can at least partially surround the disc or canopy. In addition, the hole can extend through the disc or canopy. The disc or canopy can be rigid or flexible. The disc or canopy can be flat or curved. The disc or canopy can be compressed or pushed to a closed position, for example in which it overlies the passage of fluid.

Advantageously, the cage can comprise a central support. The fluid passage can be one of two or more fluid passages around the center support. The valve member can comprise a flexible umbrella valve member. The valve member can comprise a rod, which can be connected to the central support.

In addition, the disc can be pushed by a pressure means, such as a spring, to a closed position, for example in which it covers the fluid passage. The disc or cage can comprise a seal or sealing means, for example a seal or a peripheral sealing means. The seal or sealing means can extend to the periphery of the fluid passage(s) or the disc. The seal or sealing means can be configured to seal and/or create a seal between the disc and the cage, for example when the disc is in the closed position.

The disc or canopy can be configured to move or deform in a reversible manner to a predetermined pressure difference between the interior and exterior of the battery case to prevent overpressure within the battery case.

The invention also relates to a valve member for a pressure equalizing device, the valve member comprising a rigid or flexible disc or canopy with a hole that extends through the disc or canopy and a membrane attached to the valve member and covering the hole.

The canopy can extend radially from the rod, for example to cover the fluid passages.

Advantageously, the hole is one of two or more holes through the disc or canopy. Each of the holes can be covered by the membrane or a respective membrane.

In addition, the cage can comprise a lip and/or seal. The seal can be spaced apart from the lip. The seal and lip can be configured to capture, in use, a wall of the battery case between them, for example to seal the cage in a hole in the battery case.

Also, the cage can comprise a bayonet connection. The bayonet connection can have two or more flanges, each of which can describe a portion of a lip.

The cage can comprise a valve seat. The valve member or the disc or canopy of the valve member can engage, for example, sealed against the valve seat when the disc or canopy covers the fluid passages. The cage can comprise a sealing piece. The sealing piece can comprise the seal and/or valve seat. The seal can be connected to the valve seat, for example by one or more bridging columns.

The disc or canopy can comprise one or more sealing lips, which can be configured to engage the valve seat. The one or more sealing lips can comprise a pair of sealing lips, which can be spaced apart from each other, for example the one or more sealing lips can comprise a pair of spaced apart sealing lips.

The valve seal and/or seat and/or the sealed portion can be formed integrally with the cage, for example by an overmolding process. The seal can be located on a first side, for example a bottom side, of the cage. The valve seat can be located on a second side, for example an upper side, of the cage, which can be opposite to the first side. The bypass columns can extend through the cage.

Advantageously, the device can comprise a lid, which can be mounted on the cage. The lid can be movable, for example between an open configuration, in which air can escape, in use, out of the case, and a closed configuration, in which the case is sealed.

The pressure means that pushes the disc to the closed position can be captive between the disc and the cover. The disc and/or cover can comprise a connector, for example to connect to one end of the spring. The disc can comprise a protrusion, which can be received by one end of the pressure means. The lid can comprise a housing or a socket, for example in which the other ends of the pressure means can be received. The cover housing or socket can surround at least a portion of the disc protrusion. In addition, the lid can comprise a protrusion, which can be received by one end of the pressure means, and/or the disc can comprise a housing or a socket, for example in which the other end of the pressing means can be received and/or the disc housing or socket can surround at least a portion of the lid protrusion.

The cover can be rotated between the open and closed configurations or positions. At least one of the lid and the cage can comprise a formation, for example an inclined, helical or screw-shaped formation. The formation can cooperate with a formation on the other side of the lid and cage to cause the lid to travel relative to the cage when rotated between the open and closed configurations or positions.

The cover can be screwed in between the open and closed configurations or positions. The device can comprise sealing means on one or both of the lid and/or the cage, for example that provide sealing of the case when the lid is in the configuration or the closed position.

The lid can comprise one or more windows. The cage can comprise one or more windows. The or each lid window can be aligned with the or a corresponding cage window, for example when the lid is in the open position. The or each lid window can be misaligned or offset from the corresponding one or more cage windows, for example when the lid is in the closed position. The apparatus can comprise a seal, for example a window seal, which can be configured to seal the fluid communication between the windows, for example when the lid is in the closed position.

For the avoidance of doubt, all the features described herein also apply to any aspect of the invention.

As part of this application, it is expressly provided that the various aspects, embodiments, examples and alternatives disclosed in the preceding paragraphs, in the claims and/or in the following description and drawings, and in particular the individual features thereof, can be taken separately or in any combination. In other words, all embodiments and/or features of any embodiment can be combined in any way, unless these features are incompatible.

For the avoidance of doubt, the terms “can”, “and/or”, “for example”, “for example” [sic: repeated expression] and any other similar term used herein must be interpreted as not limiting, such that any feature described herein is not necessarily required to be present. Indeed, any combination of optional features is expressly foreseen without departing from the scope of the invention, whether or not they are expressly claimed. The applicant reserves the right to amend any claim originally filed or to file any new claim accordingly, including the right to amend any claim originally filed to depend on and/or incorporate any feature of any other claim, though it is not originally claimed in this manner.

### BRIEF DESCRIPTION OF THE FIGURES

Other features and advantages of the invention will become apparent from the following detailed description, which will be understood in reference to the appended drawings, in which:

FIG. 1 illustrates a pressure equalizing device for a battery case according to an example of the invention;

FIG. 2 illustrates the device of FIG. 1 without its top cover;

FIG. 3 illustrates a side view of the device of FIG. 1 from the bottom, showing the engagement between the lid and the tubular wall;

FIG. 4 illustrates a perspective view of the device of FIG. 1 from the bottom;

FIG. 5 illustrates a cross-sectional view of the device of FIGS. 1 to 4, taken along the device main axis;

FIG. 6 illustrates a cross-sectional view of a pressure equalizing device for a battery case according to another example of the invention, taken along the main axis of the device;

FIG. 7 illustrates a perspective view of the joined device portion of FIG. 6;

FIG. 8 illustrates a cross-sectional view of the device of FIG. 6 through a plane perpendicular to the main axis of the device;

FIG. 9 illustrates a cross-sectional view of a valve member for a pressure equalizing device for a battery case according to another example of the invention;

FIG. 10 illustrates a side view of the valve member of FIG. 9 from the bottom;

FIG. 11 illustrates a pressure equalizing device for a battery case according to another example of the invention;

FIG. 12 illustrates the device of FIG. 11 without its top cover;

FIG. 13 illustrates a side view of the device of FIG. 11 from the bottom, showing the engagement between the lid and the tubular wall;

FIG. 14 illustrates a perspective view of the device of FIG. 11 from the bottom;

FIG. 15 illustrates a cross-sectional view of the device of FIGS. 11 to 14;

FIG. 16 illustrates a cross-sectional view of a pressure equalizing device for a battery case according to another example of the invention; and

FIG. 17 illustrates a perspective view of the device of FIG. 16 from the bottom.

### DETAILED DESCRIPTION OF THE INVENTION

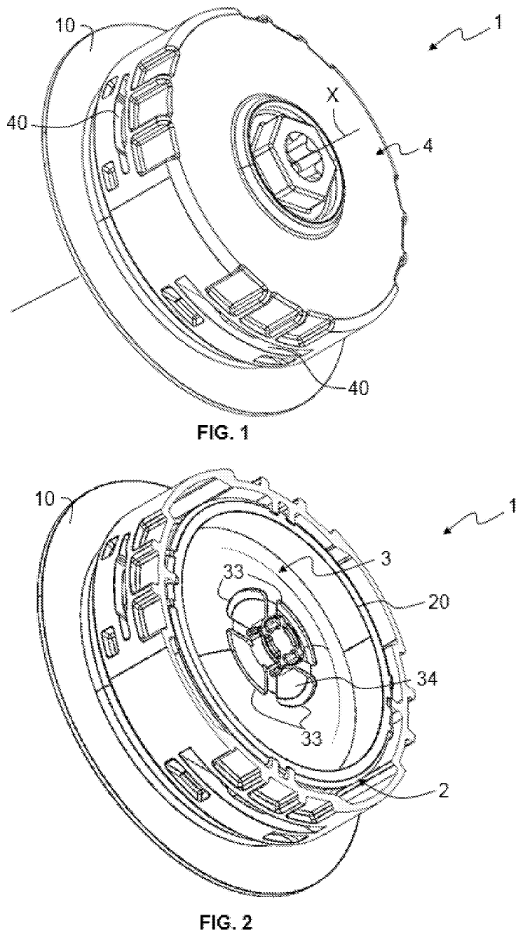

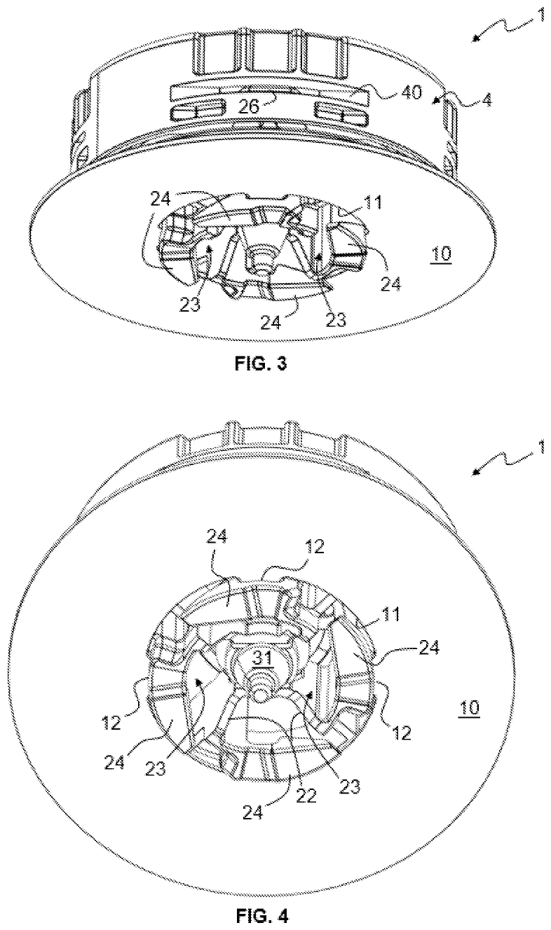

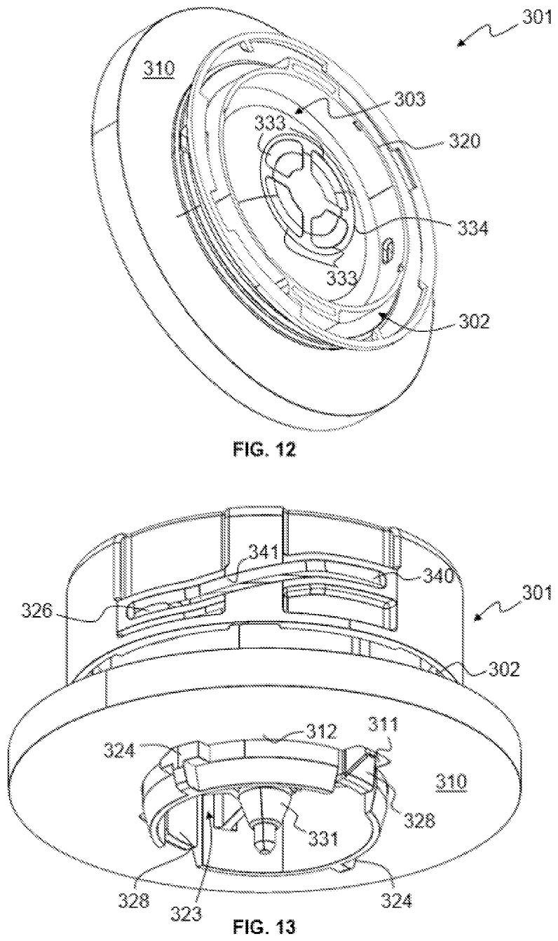

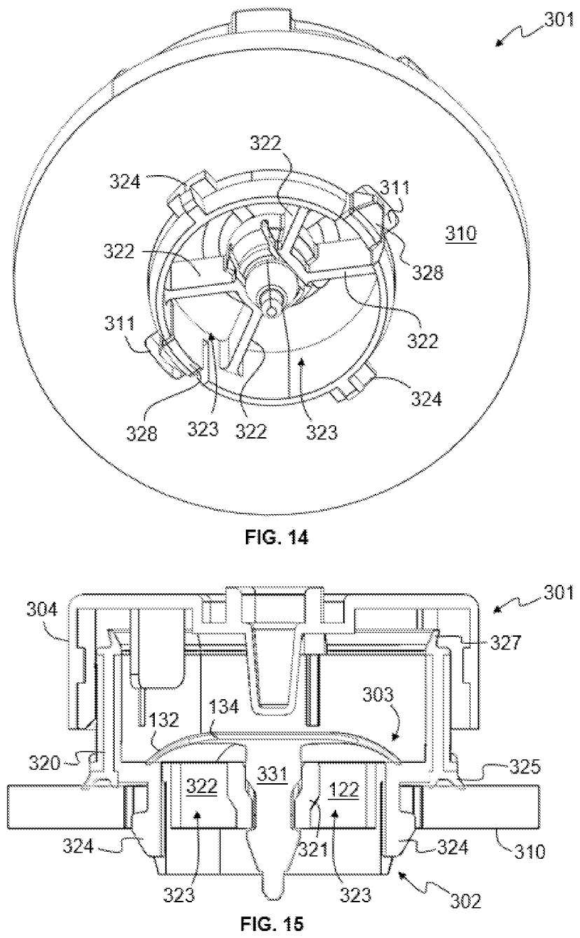

Different aspects of different embodiments according to the invention are described in more detail below, in reference to FIGS. 1 to 14.

FIGS. 1 to 5 show a pressure equalizing device 1 according to a first example, which is mounted on a battery case wall 10 (of which only a portion is shown). Device 1 comprises a primary X-axis, a cage 2, a valve member 3 that is mounted in the cage 2 and a lid 4 that is mounted on the cage 2. The battery case wall 10 comprises a hole 11 in which the device 1 is mounted.

The cage 2 comprises a tubular wall 20, a central support 21 connected to the tubular wall 20 by four radial walls 22. Fluid passages 23 are described between radial walls 22, which provide fluid communication between the interior of the battery case wall 10 and the interior of the cage 2.

Four radial flanges 24 protrude outward from the bottom end of the radial walls 22. The radial flanges 24 cooperate with four radial tabs 12 of the battery case wall 10 to provide a bayonet connection to secure the device 1 in hole 11 of the battery case wall 10. A seal 25 depends from the tubular wall 20 and the radial flanges 24 together form a lip, such that the battery case wall 10 is captive between the lip and the seal 25.

The cage 2 is therefore assembled in hole 11, this hole being installed on the top of the battery, with a ¼ turn fastening system. Such a solution makes it possible to maximize the available space of hole 11 and thereby optimize the flow of fluid through the fluid passages 23 of the cage 2. Such a profile in a ¼ turn configuration to be affixed to the battery case wall 10 thus makes it possible to obtain an optimal flow rate for venting the pressure within the battery by maximum discharging hole 11 of the battery case.

The lid 4 surrounds the tubular wall 20 of the cage 2 and covers its open end. The lid 4 comprises slots 40 that receive protrusions 26 on the tubular wall 20 to provide a snap connection between the lid 4 and the tubular wall 20. The lid 4 fits loosely to the tubular wall 20, so that air can pass between them.

The valve member 3 comprises a rod 31 connected to the central support 21 and a canopy 32 extending radially from the rod 31, which covers the fluid passages 23. The valve member 3 is therefore an umbrella valve member 3. The canopy 32 preferentially has a domed shape, and is made of a flexible material to increase the closing tension. According to one variant, canopy 32 has a flat shape. The umbrella valve member 3 can be made of a cushioning material with a high strength polytetrafluorethylene (PTFE) membrane.

The canopy 32 comprises four holes 33 through its thickness, which are covered with a membrane 34. The membrane 34 is gas permeable and impermeable to liquids to allow air to pass through it to equalize the pressure within the battery case 10 with the ambient pressure outside the battery case 10.

Preferably, the membrane 34 is overmolded in the flexible umbrella valve member 3. Alternatively, the holes 33 can be covered by a respective membrane 34. In some examples, the membrane 34 can be air impermeable and can be configured to bend sufficiently to allow some pressure equalization.

In use, air within the battery case is equalized by transmitting air through the membrane 34. If the pressure within the battery case exceeds a predetermined threshold, canopy 32 of the umbrella valve member 3 is forced to bend away from the fluid passages 23. Thus, high-pressure air can be expelled from the battery case to avoid an overpressure.

In operation, the present invention thus makes it possible to perform two pressure equalization functions. A first function, known as a degassing function, wherein the canopy 32 of the valve member 3 is deformed by the high pressure from the battery, which is the case in a thermal runaway (emergency) situation and wherein it is necessary to degas over a very short period of time, subject to the battery being exploded.

A second function, called a ventilation function, wherein the membrane 34 is like a filter that compensates for changes in air pressure to maintain the pressure within the battery equal to the external pressure. The membrane 34 can be a technical fabric impermeable (PTFE) to liquids but not to air. As a result, the membrane is adapted to allow air to pass through for reduced flow rates, thereby allowing the ventilation function.

Thus, the valve member 3, of the valve type, makes it possible to compensate for the pressure change within the battery and systematically release the pressure (emergency degassing valve). In other words, valve member 3 allows both venting to balance the internal pressure equivalent to the external pressure, degassing for a high internal pressure (emergency) within a short period of time, and being sealed to a high water pressure from outside.

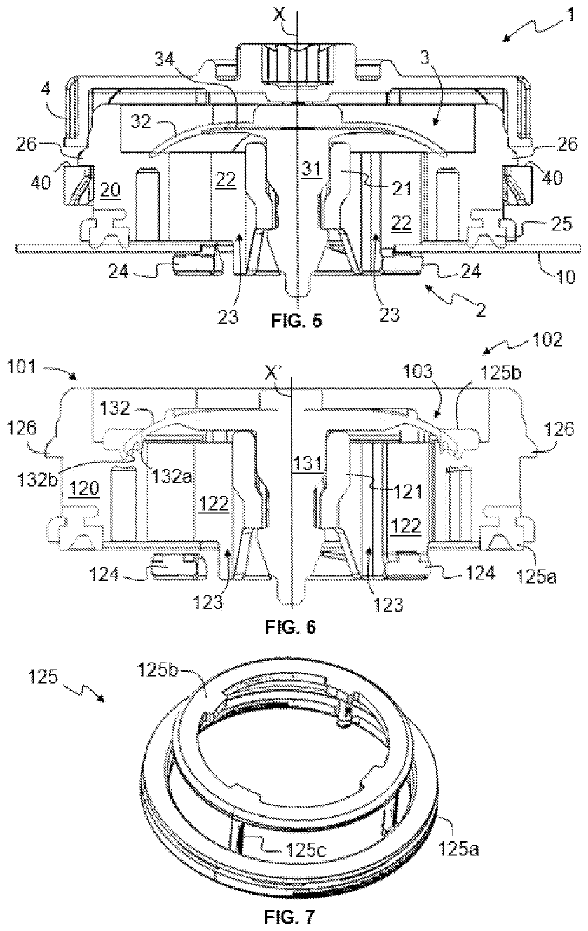

Now referring to FIGS. 6 to 8, a second example shows a pressure equalizing device 101, which is similar to the first example in that similar characteristics are marked by similar numbers incremented by 100.

The pressure equalizing device 101 according to this example differs from that of the first example in that it comprises a sealing piece 125 with a seal 125a, similar to the seal 25 of the first example, and a valve seat 125b against which canopy 132 of the valve member 103 seals under normal conditions. In addition, canopy 132 also comprises a pair of spaced apart sealing lips 132a, 132b, which are configured to engage the valve seat 125b.

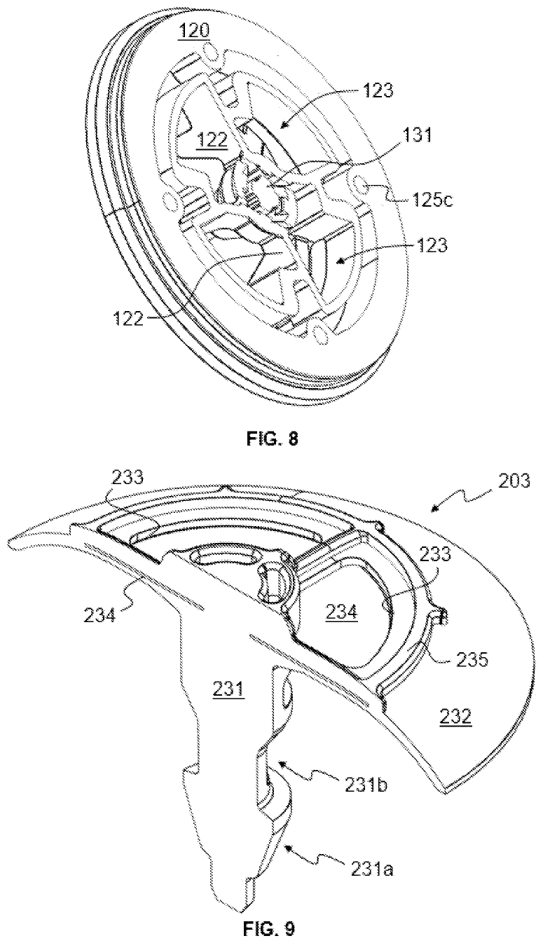

The seal 125a is connected to the valve seat 125b by four bridging columns 125c and is integrally formed with the cage 102. More precisely, and as shown more clearly in FIG. 8, the 125c bridging columns extend through holes in the cage 102, which are parallel to the primary axis X′. The sealing piece 125 is preferably molded on and in the cage 102, using a two-step overmolding process. Alternatively, the seal 125a and the valve seat 125b can be formed as different components and mounted to the cage 102.

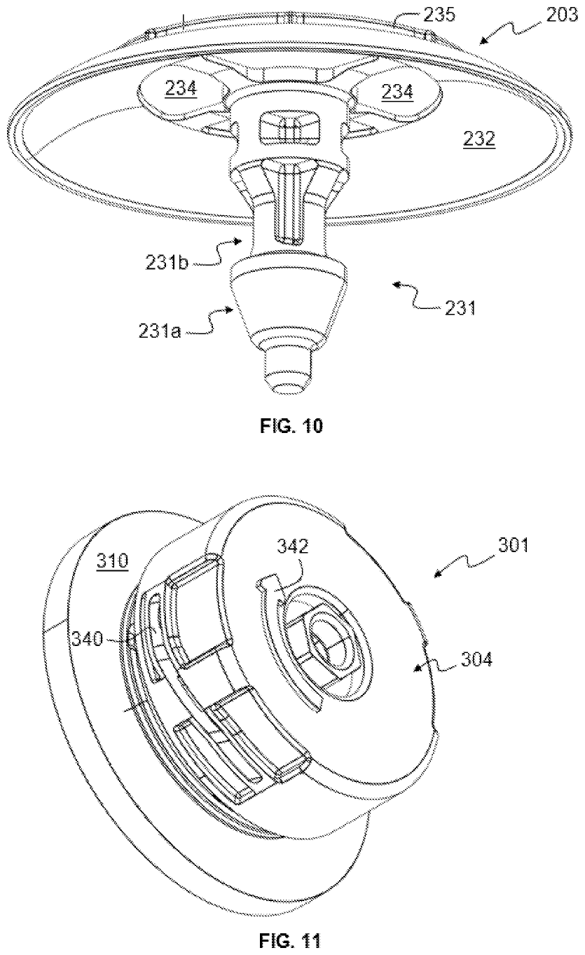

Now referring to FIGS. 9 and 10, a valve member 203 is seen according to a third example, which is similar to the first example in that similar characteristics are marked by similar numbers incremented by 200. The valve member 203 according to this example differs from that of the first example in that the canopy 232 incorporates reinforcement ribs 235 surrounding the holes 233.

As more clearly shown in FIGS. 9 and 10, the rod 231 comprises a conical end 231a and a narrowed portion 231b. The valve member 203 is mounted on a cage 2, 102 by inserting the conical end 231a of the rod 231 into the center support 21, 121 and forcing the rod 231 into the center support 21, 121 until the conical end 231a protrudes from the other end and the center support 21, 121 is captive in the narrowed portion 231b. Other arrangements are also possible.

Now referring to FIGS. 11 to 15, a pressure equalizing device 301 is seen according to a fourth example, which is similar to the first example in that similar characteristics are marked by similar numbers incremented by 300. The pressure equalizing device 301 according to this example differs from that of the first example in that the lid 304 can be rotated between the open and closed positions.

More specifically, the tubular wall 320 comprises a seal 327 around its open end and each of the slots 340 of the lid 304 comprises a helical segment 341. These helical segments 341 cooperate with the protrusions 326 of the tubular wall 320 to bring the seal 327 closer to and farther from the lid 304 during rotation.

As a result, rotating the lid 304 in the direction illustrated by the arrow 342, shown in FIG. 11, pulls the lid 304 further onto the tubular wall 320, thereby creating a sealed connection between them. This configuration can be advantageous when the battery case needs to be pressure tested. Specifically, the open position used for venting/degassing (normal operation) and the closed position to perform the 100% air leak test of the battery case.

In this example, the bayonet fastener comprises only two flanges 324, but also comprises a pair of spring lock stops 328. The tabs 312 protruding into the hole 311 extend through most of the periphery, so that the locking stoppers 328 snap into place between the tabs 312, thereby preventing rotation of the cage 302 when the lid 304 is rotated relative to it.

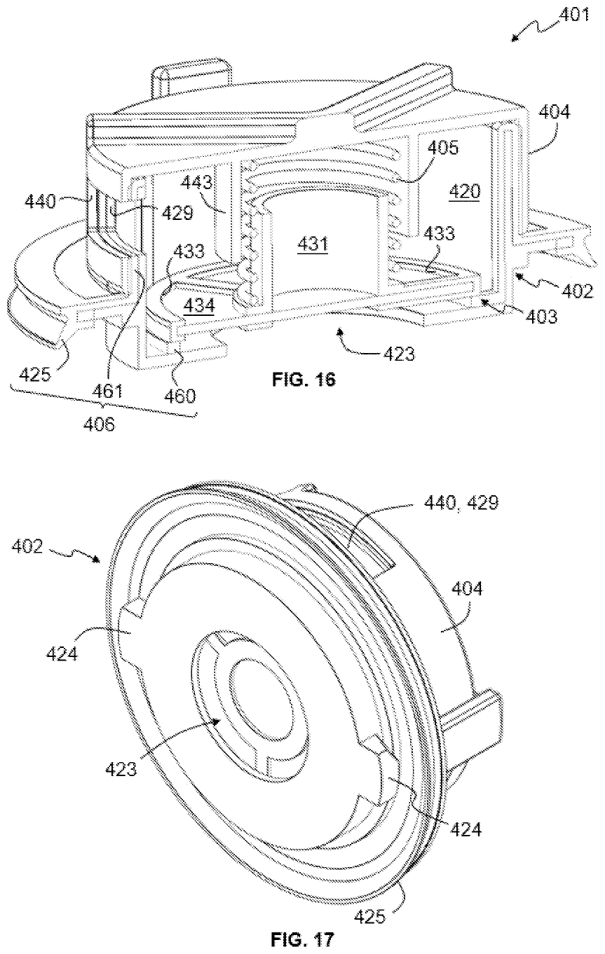

Now referring to FIGS. 16 and 17, a pressure equalizing device 401 is seen according to a fifth example, which is similar to the fourth example in that similar characteristics are marked by similar numbers incremented by 100. The pressure equalizing device 401 according to this example differs from that of the fourth example in that the umbrella valve member 303 is replaced by a disk 403 and that the rotation of the cover 404 selectively aligns the windows 440, 429 through the cover 404 and the tubular wall 420.

The disc 403 has holes 433 in its thickness, which are covered by an overmolded membrane 434, and a tubular wall 431 protrudes into the center of the disc 403. The lid 404 also comprises a dependent tubular wall 443, which is aligned with the tubular wall 431 of the disc 403 and surrounds it. The device 401 comprises a spring 405, a first end of which surrounds the tubular wall 431 of the disc 403 and a second end of which is received in the tubular wall 443 of the lid 404. The spring 405 pushes the disc 403 to a closed position in which it covers the fluid passage 423.

In this example, a sealing material 406 is molded on areas of the cage 402. More specifically, the sealing material 406 comprises the seal 425 which depends from the tubular wall 420 as well as a disc seal 460 surrounding the fluid passage 423, which engages the disc 403 when in the closed position. The sealing material 406 also comprises a window seal 461 surrounding the window 429 through the cage 402.

As a result, fluid can pass from the battery case through the fluid passage 423, through the membrane 434 (or between the cage 402 and the disc 403 when moved), and exit through the windows 429, 440 when the lid 404 is in the open position (shown in FIG. 16). However, when the cover 404 is rotated such that the windows 429, 440 are no longer aligned, the window seal 461 hermetically closes the fluid communication during a 100% air leak test of the battery case.

The person skilled in the art will be aware that several variants of the aforementioned embodiments are conceivable without departing from the scope of the invention.

Throughout the description and claims of this specification, the words “comprise” and “contain” and their variations mean “including but not limited to” and are not intended for (and do not exclude) other parts, additives, components, entireties, or steps. Throughout the description and claims of this specification, the singular includes the plural, unless the context requires otherwise. In particular, when the indefinite article is used, the specification should be understood to comprise the plural as well as the singular, unless the context requires otherwise.

Any features, integers, characteristics, compounds or groups described in connection with a particular aspect, embodiment or example of the invention are to be understood as being applicable to any other aspect, embodiment or example described herein, unless inconsistent therewith. All of the features disclosed in this specification (including the claims, abstract and accompanying drawings), and/or all of the steps of a method or of a process thus disclosed, can be combined in any combination other than combinations in which at least some of such features and/or steps are mutually exclusive. The invention is not limited to the details of all of the preceding embodiments. The invention extends to any new feature or any new combination of the features disclosed in this specification (including the claims, abstract and accompanying drawings), or to any new feature or any new combination of the steps of any method or process thus disclosed.

The reader's attention is drawn to all papers and documents that are filed concurrently or prior to this specification in connection with this application and that are open for public inspection with this specification, and the content of all such papers and documents is incorporated here by reference.

1. A pressure equalizing device for a battery case, the device comprising:
a cage describing a fluid passage; and
a valve member covering the fluid passage, the valve member comprising a hole through its thickness and a membrane attached to the valve member and covering the hole,
wherein the membrane is configured to equalize, in use, pressure within the battery case with ambient pressure outside the battery case
while the valve member is configured to move or deform in a reversible manner to a predetermined pressure difference between an interior and an exterior of the battery case to prevent overpressure within the battery case.

2. The pressure equalizing device according to claim 1, wherein the membrane is permeable to gas and impermeable to liquids to allow air to pass through it to equalize the pressure within the battery case with the ambient pressure outside the battery case.

3. The pressure equalizing device according to claim 1, wherein the cage comprises a central support and the fluid passage is one of two or more fluid passages around the central support, wherein the valve member comprises a rod connected to the central support and a canopy extending radially from the rod to cover the fluid passages.

4. The pressure equalizing device according to claim 3, wherein the hole is one of two or more holes through the canopy, each of which is covered by the membrane or a respective membrane.

5. The pressure equalizing device according to claim 3, wherein the cage comprises a valve seat against which the canopy sealingly engages when the canopy is covering the fluid passages.

6. The pressure equalizing device according to claim 5, wherein the canopy comprises a pair of interspaced sealing lips, which are configured to engage the valve seat.

7. The pressure equalizing device according to claim 5, wherein the cage comprises a lip and a seal spaced apart from the lip that are configured to capture, in use, a wall of the battery case between them to seal the cage in a hole of the battery case.

8. The pressure equalizing device according to claim 7, wherein the seal is connected to the valve seat by bridging columns that extend through the cage.

9. The pressure equalizing device according to claim 7, wherein the cage comprises a bayonet connection with two or more flanges each describing a portion of the lip of the cage.

10. The pressure equalizing device according to claim 1, wherein the device comprises a lid that is movable between an open configuration, wherein air can escape, in use, out of the case, and a closed configuration, wherein the cage is sealed.

11. The pressure equalizing device according to claim 10, wherein the lid can be rotated between the open and closed configurations.

12. The pressure equalizing device according to claim 11, wherein at least one of the lid and of the cage comprises an inclined, helical, or screw-shaped formation.

13. The pressure equalizing device according to claim 12, wherein the formation cooperates with a formation on the other of the lid and of the cage to cause the lid to translate relative to the cage when rotated between the open and closed configurations.

14. The pressure equalizing device according to claim 10, wherein the device comprises sealing means on one or both of the lid and/or of the cage that seal the case when the lid is in the closed configuration.

15. A valve member for a pressure equalizing device according to claim 1, the valve member comprising a rigid or flexible disc or canopy with a hole that extends through the disc or canopy and a membrane attached to the valve member and covering the hole.
